(19) United States
(12) Patent Application Publication
(10) Pub. No.: US 2008/0125117 A1
(43) Pub. Date: May 29, 2008

(54) Method and system for providing roaming services to outbound roamers using home network Gateway Location Register

(76) Inventor: John Yue Jun Jiang, Danville, CA (US)

Correspondence Address: ARENT FOX LLP, 1050 CONNECTICUT AVENUE, N.W., SUITE 400, WASHINGTON, DC, 20036, US

(21) Appl. No.: 11/979,538

(22) Filed: Nov. 5, 2007

Related U.S. Application Data
(63) Continuation-in-part of application No. 11/375,577, filed on Mar. 15, 2006.
Application No. 11/375,577 is a continuation-in-part of application No. 11/374,427, filed on Mar. 14, 2006.
Application No. 11/374,427 is a continuation-in-part of application No. 10/918,645, filed on Aug. 13, 2004.
Application No. 10/918,645 is a continuation-in-part of application No. 10/782,681, filed on Feb. 18, 2004.
Application No. 10/782,681 is a continuation-in-part of application No. 11/366,017, filed on Mar. 2, 2006.
Application No. 11/366,017 is a continuation-in-part of application No. 11/819,164, filed on Jun. 25, 2007.
Application No. 11/819,164 is a continuation-in-part of application No. 11/402,128, filed on Apr. 12, 2006.
(60) Provisional application No. 60/856,301, filed on Nov. 3, 2006.
(60) Provisional application No. 60/906,234, filed on Mar. 12, 2007.
(60) Provisional application No. 60/905,586, filed on Mar. 8, 2007.
(60) Provisional application No. 60/900,134, filed on Feb. 8, 2007.

(51) Int. Cl. H04Q 7/20

(52) U.S. Cl. 455/433

(57) ABSTRACT

The present invention provides a method for providing roaming services to a subscriber associated with an HPMN, while the subscriber is registered with the VPMN. The method includes allocating a pool of Global Titles (GTs) to a Gateway Location Register (GLR) that is associated with the HPMN, where the pool of GTs corresponds to one or more HLRs associated with the HPMN. The method further includes facilitating mobile communication of the subscriber in the VPMN using the allocated pool of GTs.

### RELATED APPLICATIONS

This application claims the benefit of U.S. Provisional Patent Application No. 60/856,301 titled “Smart Gateway Location Register” filed on Nov. 3, 2006, and of U.S. Provisional Patent Application No. 60/906,234 with the same title filed on Mar. 12, 2007, and of U.S. Provisional Patent Application No. 60/905,586 with same title filed on Mar. 8, 2007, and of U.S. Provisional Patent Application No. 60/900,134 with same title filed on Feb. 8, 2007. This application is a continuation-in-part of U.S. patent application Ser. No. 11/375,577 titled “Method and Apparatus for Defense Against Defense Against Network Traffic Redirection” filed on Mar. 15, 2006, and of U.S. patent application Ser. No. 11/374,427 titled “Method and Apparatus for Defense Against Defense Against Network Traffic Redirection” filed on Mar. 14, 2006, and of U.S. patent application Ser. No. 10/918,645 titled “Signaling Gateway with Multiple IMSI with Multiple MSISDN (MIMM) Service in a Single SIM for Multiple Roaming Partners” filed on Aug. 13, 2004, and of U.S. patent application Ser. No. 10/782,681 titled “Providing Multiple MSISDN Numbers in a Mobile Device with a Single IMSI” filed on Feb. 18, 2004, and of U.S. patent application Ser. No. 11/366,017 titled “Dynamic Camel Approach for Implementing Call Control Services for Outbound Roamers” filed on Mar. 2, 2006, and of U.S. patent application Ser. No. 11/819,164 titled “A Network Based Framework for Retaining Inbound Roamers—Inbound Traffic Redirection Based on HLR Errors or VLR Errors” filed on Jun. 25, 2007, and of U.S. patent application Ser. No. 11/402,128 titled “Method and Apparatus for Redirection of Inbound Roamer Traffic” filed on Apr. 12, 2006. All of the aforementioned related patent applications are incorporated herein in their entirety by this reference.

### FIELD OF THE INVENTION

The present invention generally relates to mobile communication of roamers. More specifically, the present invention relates to facilitating mobile communication for outbound roamers of a home network roaming in a visited network, using a Gateway Location Register (GLR).

### BACKGROUND OF THE INVENTION

In the wireless communication industry, there is rising competition among various network operators to increase their roaming revenues. To enhance roaming revenues, the network operators commonly offer various roaming services in form of Value Added Services (VASs) to their outbound roamers.

Some of these VASs can be provided to outbound roamers (who are subscribers of a home network and roaming in a visited network) using one or more application logic, such as, but not limited to, providing the outbound roamers with a visited network Mobile Station International Subscriber Directory Number (MSISDN) to make calls at local rates in the visited network, allowing the outbound roamers having a dual International Mobile Subscriber Identity (IMSI) Subscriber Identity Module (SIM) in the visited network to make calls at local rates, removing a call barring parameter to enable outbound roamers' mobile communication, and restoring mobile communication of the outbound roamer when his handset gets stuck in the visited network.

In order to provide these VASs to the outbound roamers, the home network operators need a central location (or a central node) to deploy these application logic while complying with international standards set forth by Global System for Mobile communication Association (GSMA) for inter-operator communication. Many home network operators add new signaling node(s) or configure their existing signaling nodes in their networks. In an exemplary case, the home network operator may deploy a Gateway Location Register (GLR) as a signaling node to optimize the registration process (i.e. Location Update (LUP) process). This prior art GLR is positioned between the visited network's Visited Location Register (VLR)/Serving General Packet Radio System Support Node (SGSN) and the home network's Home Location Register (HLR).

The prior art GLR is only able to cache subscriber profile information of its outbound roamers during their first LUP attempt at the visited network's VLR. Using the cached profile information, the prior art GLR responds to subsequent LUP attempts by these outbound roamers at the visited network's VLR by acting as a pseudo-HLR to these outbound roamers. The prior art GLR is hence able to hide home networks HLRs from visited networks for security purpose. However by using the prior art GLR, the home network operator is unable to provide any VASs to its outbound roamers, and is limited to only caching of subscriber profile information during LUP process hence hiding home network HLRs from the visited networks.

The prior art GLR uses a single Global Title (GT) of the home network while communicating with various elements in the visited network. The GT is a unique address that is used to differentiate network elements within a network topology. The prior art GLR's GT presents an address of an HLR in the home network when interacting with a VLR in the visited network, and an address of a VLR in the visited network when interacting with an HLR in the home network. In this single GT approach, the GLR always uses the same GT to interact with all VLRs in the visited network and all HLRs in the home network. Since the prior art GLR represents all HLRs by the single GT while interacting with network elements in the visited network, the prior art GLR is unable to emulate individual network elements in the home network. This limits the home network operator's ability to provide VASs to its outbound roamers.

Moreover, due to this single GT, a home network application is unable to cache correct capabilities of the home network's HLR. Furthermore, due to the use of single GT, the prior art GLR is unable to provide redundancy in case the GLR fails. This is because a signaling node in the home network (such as a Signaling Transfer Point (STP)) is unable to route Signaling Connection Control Part (SCCP) messages of outbound roamers, originating from the visited network and destined for an HLR in the home network, to the destined HLR since there is no possibility of maintaining a routing at the STP corresponding to each HLR in the home network, independently. This eventually disrupts signaling whenever the GLR goes down, resulting in loss of roaming revenue for the home network operator.

In accordance with the foregoing, there is a need in the art of a system, a method, and a computer program product, which provides a home network operator with a GLR (or enhances the functionality of its existing GLR) that enables the home network operator to provide various network based VASs (using the application logic) at a centralized location in the network, in addition to handling the GLR failure scenario.

### SUMMARY

The present invention is directed towards a method for providing roaming services to a subscriber associated with an HPMN, while the subscriber is registered with a VPMN. The method includes allocating a pool of Global Titles (GTs) to a Gateway Location Register (GLR) that is associated with the HPMN, where the pool of GTs corresponds to one or more HLRs associated with the HPMN. Finally, the method includes facilitating mobile communication of the subscriber in the VPMN.

Another aspect of the present invention presents a system for providing roaming services to a subscriber associated with an HPMN, while the subscriber is registered with a VPMN. The system includes a GLR associated with the HPMN. The GLR is allocated a pool of GTs corresponding to one or more HLRs associated with the HPMN. Further, the GLR facilitates mobile communication of the subscriber in the VPMN.

Yet another aspect of the present invention provides a computer program product including a computer usable program code for providing roaming services to a subscriber associated with an HPMN, while the subscriber is registered with a VPMN by allocating a pool of GTs to a GLR that is associated with the HPMN, where the pool of GTs correspond to one or more HLRs associated with the HPMN. Further, the computer program product facilitates mobile communication of the subscriber in the VPMN using the GLR.

### BRIEF DESCRIPTION OF DRAWINGS

In the drawings, the same or similar reference numbers identify similar elements or acts.

FIG. 1 represents a prior art system architecture of a Gateway Location Register (GLR) that is deployed in a Visited Public Mobile Network (VPMN);

FIG. 2 represents a flowchart for implementing the GLR having enhanced functionalities in the HPMN to provide roaming services to subscribers of a Home Public Mobile Network (HPMN), in accordance with an embodiment of the present invention;

FIG. 3 represents a system architecture of the GLR in the VPMN, in accordance with an embodiment of the present invention.

FIGS. 4A and 4B represent a flow diagram for detecting and handling a stuck handset case, when a handset of a subscriber associated with the HPMN is stuck during its registration attempt at the VPMN, in accordance with an embodiment of the present invention;

FIG. 5 represents a flow diagram for restoring Mobile Terminated (MT) call, MT Short Message Service (SMS), and data capability (i.e. General Packet Radio System (GPRS)) of the subscriber, when the subscriber's handset is stuck during its registration attempt at the VPMN, in accordance with an embodiment of the present invention;

FIG. 6 represents a flow diagram for removing a Third Generation of mobile (3G) parameter using the GLR when the HPMN has no 3G roaming agreement with the VPMN, in accordance with an embodiment of the present invention.

### DETAILED DESCRIPTION

In the following description, for purposes of explanation, specific numbers, materials and configurations are set forth in order to provide a thorough understanding of the present invention. It will be apparent, however, to one having ordinary skill in the art that the present invention may be practiced without these specific details. In some instances, well-known features may be omitted or simplified, so as not to obscure the present invention. Furthermore, reference in the specification to “one embodiment” or “an embodiment” means that a particular feature, structure or characteristic, described in connection with the embodiment, is included in at least one embodiment of the present invention. The appearance of the phrase “in an embodiment”, in various places in the specification, does not necessarily refer to the same embodiment.

The present invention provides a system, a method, and a computer program product that provides roaming services to subscribers of a home network that are registered with a visited network. An operator of the home network deploys a Gateway Location Register (GLR) having enhanced functionalities to provide roaming services to its outbound subscribers. It will be apparent to a person skilled in the art that roaming services include standard call and non-call related activities, such as, but not limited to, Mobile Originated (MO) call, Mobile Terminated (MT) call, Short Message Service (SMS), Packet Data Network (PDN), and other Value Added Services (VAS) such as SMS forwarding and SMS filtering. Furthermore, both the method and the system allow sharing of the GLR between multiple home network operators, and also handle GLR fail over scenario. Various enhanced functionalities of the GLR will be described later in context with various embodiments of the present invention.

### Prior Art GLR System Implementation

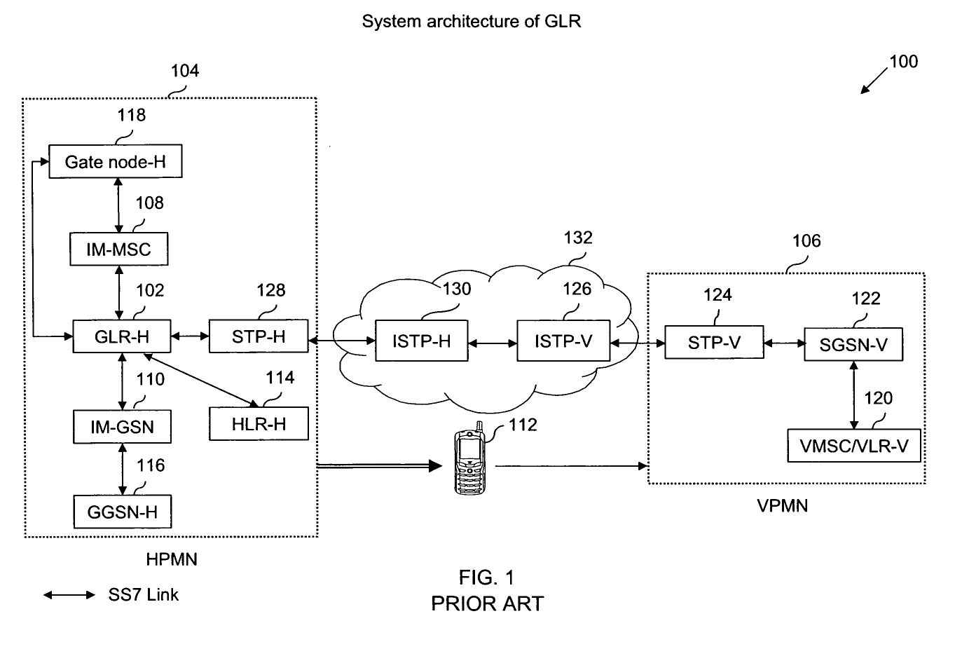

In earlier solutions, the GLR was allocated a single Global Title (GT) corresponding to the home network, in order to allow the GLR to interact with various Home Location Registers (HLRs) associated with the home network and various Visited Location Registers (VLRs) and Serving GPRS Support Nodes (SGSNs) associated with the visited network. Moreover, the GLR was introduced with the idea of hiding home network HLRs from visited networks to ensure security, and the GLR was involved only during Location Update (LUP) process of outbound roamers that were roaming in the visited network. FIG. 1 represents a prior art system 100 that illustrates a logical network model of a GLR 102. Prior art system 100 includes a Home Public Mobile Network (HPMN) 104 (i.e. the home network) and a Visited Public Mobile Network (VPMN) 106 (i.e. the visited network), where HPMN 104 operator deploys GLR 102. HPMN 104 further includes an Intermediate Mobile Switching Center (IM-MSC) 108 and an Intermediate GSN (IM-GSN) 110, both coupled to GLR 102 that is deployed in HPMN 104. It will be apparent to a person skilled in the art that IM-MSC 108 is a logical node and represents a Mobile Switching Center (MSC) in HPMN 104, whereas IM-GSN 110 represents an SGSN for General Packet Radio System (GPRS) Tunneling Protocol (GTP) signaling termination to HPMN 104 and represents a Gateway GPRS Support Node (GGSN) to VPMN 106. Since GLR 102 resides in HPMN 104, it is hereinafter referred to as GLR-H 102. Moreover, for the sake of convenient reference, GLR-H 102, IM-MSC 108, and IM-GSN 110 are hereinafter collectively referred to as GLR-H 102. When a subscriber 112 that is associated with HPMN 104, makes his first attempt to register with VPMN 106, the operator of HPMN 104 caches profile information of subscriber 112 using GLR-H 102.

Furthermore, HPMN 104 includes an HLR 114, a GGSN 116, and a Gate Node 118. Since HLR 114, GGSN 116, and Gate Node 118 reside in HPMN 104, they are hereinafter referred to as HLR-H 114, GGSN-H 116, and Gate Node-H 118, respectively. It will be apparent to a person skilled in the art that HLR-H 114 stores profile information corresponding to all subscribers of HPMN 104, whereas Gate Node-H 118 represents a Gateway MSC (GMSC), a Gateway Mobile Location Centre (GMLC), or a Short Message Service GMSC (SMS-GMSC). In an embodiment of the present invention, GLR-H 102 is in active mode, i.e., it facilitates exchange of all LUP process related signaling messages between VPMN 106 and HPMN 104.

Prior art system 100 further includes in VPMN 106, a VLR 120 that is integrated with a VMSC, and an SGSN 122. Since VLR 120 communicates with its integrated VMSC using an internal communication interface (called B-interface) and a Sub System Number (SSN), and they collectively reside in VPMN 106, they are hereinafter interchangeably referred to as VMSC/VLR-V 120. However both VLR and VMSC may have different logical addresses. Moreover, since SGSN 122 resides in VPMN 106, it is hereinafter referred to as SGSN-V 122.

Subscriber 112's signaling in VPMN 106 is routed to HPMN 104 via a roaming Signaling Transfer Point (STP) 124 and an International STP (ISTP) 126. Since STP 124 and ISTP 126 reside in VPMN 106, they are hereinafter referred to as STP-V 124 and ISTP-V 126, respectively. Similarly, subscriber 112's signaling in HPMN 104 is routed to VPMN 106 via an STP-H 128 connected to an ISTP-H 130. Both ISTP-H 130 and ISTP-V 126 communicate with each other via a Signaling System #7 (SS7) signaling architecture 132 The signals exchanged between different networks are Transaction Capabilities Application Part (TCAP) including Mobile Application Part (MAP), Camel Application Part (CAP) and the like based signals. In another embodiment of the present invention, the signals exchanged are Signaling Connection Control Part (SCCP) based routing signals. It will be apparent to a person skilled in the art that any network element in HPMN 104 and VPMN 106 may communicate with each other via SS7 signaling architecture 132. It will also be apparent to a person skilled in the art that VPMN 106 and HPMN 104 may also include various other network components (not shown in FIG. 1), depending on the architecture under consideration.

As indicated earlier, GLR-H 102 in prior art system 100 is allocated single GT for interacting with various VLRs (and SGSNs) in VPMN 106 and various HLRs in HPMN 104. Moreover, GLR-H 102 is involved only during LUP process of outbound roamers in VPMN 106. The allocation of single GT to GLR-H 102 has various problems such as: VPMN 106's roaming traffic gets affected in case GLR-H 102 fails, and HPMN applications that try to cache capabilities of HLRs in HPMN 104 may capture incorrect information. Moreover, various outbound roamers that are not associated with HPMN 104 may get affected when HLR-H 114 is restarted.

### HPMN GLR Implementation in the Present Invention

The present invention in accordance with various embodiments provides solutions to various problems by allocating GLR-H 102 with a pool of GTs based on requirement(s) of the operator of HPMN 104. HPMN 104 operator uses the allocation of pool of GTs to facilitate mobile communication of its outbound roamer(s). The detailed explanation of this pool allocation is given later in context with various embodiments of the present invention.

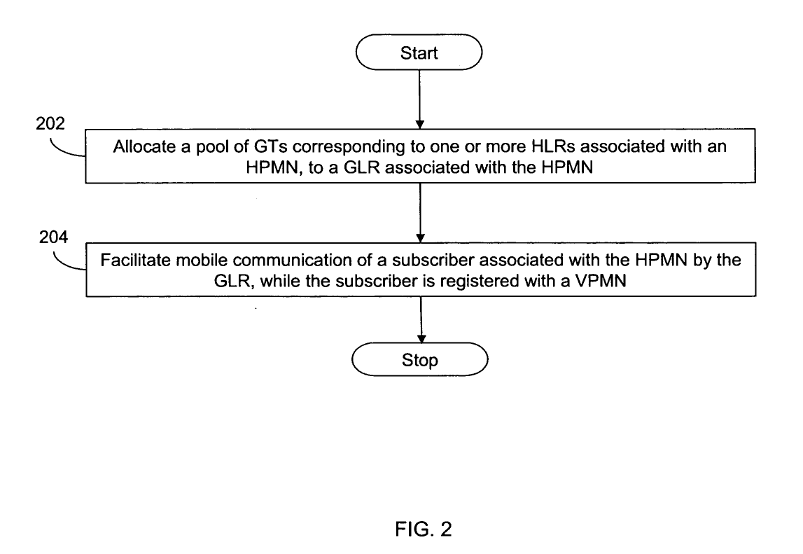

FIG. 2 is a flowchart for implementing GLR-H 102 having enhanced functionalities in HPMN 104 in order to provide roaming services to these outbound roamers, in accordance with an embodiment of the present invention. At step 202, an operator of an HPMN allocates a pool of GTs to a GLR, where the pool of GTs corresponds to one or more HLRs associated with the HPMN. In an embodiment of the present invention, GLR-H 102 is allocated a pool of GTs corresponding to each HLR in HPMN 104. For example, if an HLR-1 has a GT-A and an HLR-2 has a GT-B (both HLR-1 and HLR-2 are in HPMN 104), then GLR-H 102 is allocated a GT-1 for emulating HLR-1 and a GT-2 for emulating HLR-2. This pool of GT-1, GT-2 and so on, has a one-to-one mapping with the actual GTs of HLRs (GT-A, GT-B and so on). The operator of HPMN 104 can implement this allocation technique to deal with the above mentioned problems in prior art GLR solutions (which used single GT per HPMN).

Finally, at step 204, the GLR facilitates mobile communication of a subscriber associated with the HPMN, while he is registered with the VPMN. In an embodiment of the present invention, GLR-H 102 uses the pool of GTs corresponding to one or more HLRs, in order to facilitate mobile communication of subscriber 112 in VPMN 106. In another embodiment of the present invention, an additional application logic module coupled to GLR-H 102 applies one or more sets of application logic to provide VAS to subscriber 112 (and other outbound roamers). These sets of application logic and various other enhanced functionalities of GLR-H 102 will be explained later in context with various embodiments of the present invention.

As mentioned earlier, one of the problems with existing solutions is that since various HLRs in HPMN 104 may have different capabilities (for example, 2G or 3G), always presenting the same GT (i.e. GT of GLR-H 102) in all LUPs on different HPMN 104 HLRs may confuse some HPMN applications. For example, an HPMN application that triggers a message towards HPMN 104 to determine Second Generation of mobile (2G) or Third Generation of mobile (3G) capabilities of subscriber 112 may end up caching incorrect information. In an embodiment of the present invention, HLR-H 114 sends a RESET message to GLR-H 102, which acts as a VLR of subscriber 112 for HLR-H 114. It will be apparent to a person skilled in the art that the RESET message includes an HLR number or an International Mobile Subscriber Identity (IMSI) list of the affected subscribers as the parameters. Thereafter, GLR-H 102 relays the RESET message to the actual VLR associated with VPMN 106, with GLR-H 102 GT as the HLR number, and the received IMSI list as the parameters in the RESET message. However the VLR may only look at the HLR number parameter in the RESET message. On the other hand, in the prior art GLR implementation, when GLR-H 102 used single GT, upon receiving the RESET message from HLR-H 114, GLR-H 102 sends this RESET message to many other VPMN 106 VLRs, which ideally should not be affected by the reset of HLR-H 114.

### HPMN GLR with Enhanced Functionality of Providing Correct HLR Capabilities and Handling an HLR RESET Scenario

Hence in order to overcome the above mentioned problems, the present invention allocates the pool of GTs corresponding to each HLR (i.e. one or more HLRs) associated with HPMN 104, to GLR-H 102, in accordance with one embodiment of the present invention. This means that GLR-H 102 can now use a separate GLR-H 102 GT for each HLR associated with HPMN 104. By doing so, the HPMN application can have a distribution view of each of these HLRs, while the presence of GLR-H 102 and actual location of HPMN 104 HLRs is still hidden from the HPMN application (hence reducing possible security risks). Also, the RESET message from HLR-H 114 is unable to affect mobile communication of outbound roamers associated with other HLRs of the same HPMN 104. In other words, the RESET of HLR-H 114 affects the mobile communication of only those outbound roamers who are associated with HLR-H 114.

### HPMN GLR Implementation Using Real HLR GTs

The present invention in an embodiment describes an identity mapping technique. In this technique, HPMN 104 operator allocates a pool of actual HLR GTs to GLR-H 102, thereby mapping the identity of HLRs to GLR-H 102. In contrast to the above embodiment, this identity mapping technique uses the GT of an HLR, rather than using a new GT corresponding to the HLR. In an exemplary case, upon receiving an ‘X’ message from HLR-H 114 with Called Party Address (CdPA) as a Signal Point Code (SPC) of VMSC/VLR-V 120 and Calling Party Address (CgPA) as an SPC of HLR-H 114, GLR-H 102 uses an HLR-H 114 GT as the CgPA to interact with VMSC/VLR-V 120. This eliminates the requirement of additional GTs, since it uses the existing HLR GTs to form the pool of GTs that is used by GLR-H 102.

### Handling of HPMN GLR Failure Scenario

Moreover, in the prior art GLR implementation, when GLR-H 102 goes down (for example, due to malfunctioning or improper software upgrade of GLR-H 102), all E.214 (i.e. Mobile Global Title) signaling messages from VPMN 106 to GLR-H 102 and all E.164 (i.e. dialed number) signaling messages directly to GLR-H 102 are affected. In other words, all MT services of all outbound roamers (i.e. HPMN 104 subscribers that are roaming in VPMN 106), irrespective of their HLRs get affected due to GLR-H 102 failure. Hence in order to overcome this problem, in accordance with an embodiment of the present invention, the pool of GLR-H 102 GTs corresponding to one or more HLRs in HPMN 104 is used. However this requires configuring an STP associated with HPMN 104 (i.e. STP-H 128 or ISTP-H 130) to redirect either all signaling messages or different blocks of E.214 signaling messages, corresponding to the outbound roamers of each HLR (including subscriber 112 corresponding to HLR-H 114), to GLR-H 102. In other words, STP-H 128 (or ISTP-H 130) is configured for each GT of GLR-H 102 (i.e. for each HLR in HPMN 104), to route these signaling messages to an SPC of GLR-H 102. The signaling messages correspond to various MAP messages such as, but not limited to, a Send Authentication Information (SAI), a LUP (corresponding to a registration message), an Insert Subscriber Data (ISD), a Send Routing Information (SRI), a Send Routing Information for Short Message (SRI-SM), a RestoreData, and a Provide Roaming Number (PRN). In another embodiment of the present invention, when GLR-H 102 fails, STP-H 128 (or ISTP-H 130) is configured for providing failover support by routing signaling messages with a GT of GLR-H 102 to the GT's corresponding HLR, instead of GLR-H 102. For example, when GLR-H 102 fails, and STP-H 128 (or ISTP-H 130) receives a signaling message originating from VPMN 106 and intended for HPMN 104, it (i.e. STP-H 128 or ISTP-H 130) redirects the received message to an SPC of HLR-H 114 or an HLR-X depending on whether GLR-H 102 GT in that signaling message corresponds to HLR-H 114 or HLR-X, respectively.

This way, even when GLR-H 102 goes down for any reason, STP-H 128 (or ISTP-H 130) can still route all signaling messages from VPMN 106 on the GLR-H 102 GT towards the corresponding HLR. Moreover, when subscriber 112 moves to a different VLR (that is other than its current VLR-V 120) in VPMN 106, GLR-H 102 can still directly respond to signaling messages (like LUP etc.) from VPMN 106, without relaying the LUP message to HLR-H 114, unless subscriber 112 wishes to use new capabilities of his new VLR, which need to be confirmed with HLR-H 114.

### Handling Selected Signaling Messages Using an HPMN GLR and HLR MAP Interface Module Under the Present Invention

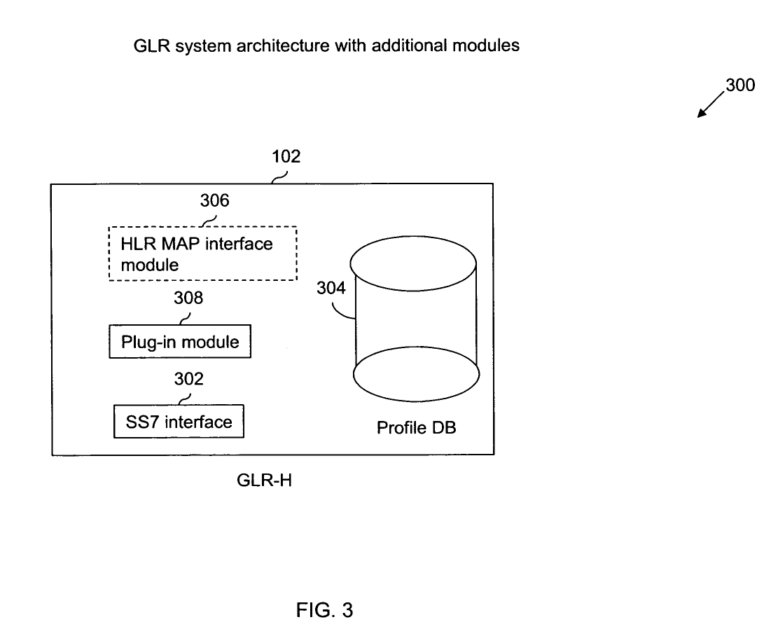

As mentioned earlier in the context of the present invention, GLR-H 102 can perform various enhanced functionalities, which were not performed in the prior art GLR implementations. FIG. 3 represents a system architecture 300 of GLR-H 102, in accordance with an embodiment of the present invention. The system architecture 300 includes an SS7 interface 302 and a profile Database (DB) 304. GLR-H 102 uses SS7 interface 302 to interface with various signaling units, whereas profile DB 304 stores information such as, but not limited to, subscriber profile information and VMSC/VLR address of outbound roamers. Furthermore, GLR-H 102 includes an optional HLR MAP interface module 306 that is a configurable module inside GLR-H 102. It enhances the functionalities of GLR-H 102 by allowing GLR-H 102 to respond to some selected signaling messages, intended for VPMN 106 and originating from HPMN 104, eventually resulting in facilitating mobile communication of subscriber 112 in VPMN 106. Since HLR MAP interface module 306 is an optional component in GLR-H 102, it is represented with dotted lines in FIG. 3. It will be apparent to a person skilled in the art that since HLR MAP interface module 306 works as an integrated unit inside GLR-H 102, functionalities of HLR MAP interface module 306 may also be incorporated as functionalities of GLR-H 102. The selected signaling messages handled by HLR MAP interface module 306 includes, but are not limited to:
a) SRI-SM: This allows GLR-H 102 to respond an SRI-SM query on subscriber 112's MSISDN (hereinafter interchangeably referred to as MSISDN-A) with an IMSI of subscriber 112 (hereinafter referred to as IMSI-A), along with the VMSC/VLR-V 120 (or SGSN-V 122) address of subscriber 112, in order to provide optimized SMS delivery. In another embodiment of the present invention, GLR-H 102 returns location information and IMSI-A in response to the SRI-SM query. For example, when a first node (like a signal gateway or any other application) in HPMN 104 sends the SRI-SM query to GLR-H 102, VMSC/VLR-V 120 address is returned along with the IMSI-A. The first node can then issue a MAP Provide Subscriber Location (PSL) message to VMSC/VLR-V 120.
b) SRI: This allows GLR-H 102 to respond an SRI query with an MSRN of subscriber 112, after sending a PRN message to a known VLR address of subscriber 112, in order to provide optimized call delivery. For example, when GLR-H 102 receives the SRI query from a second node (like a GMSC) in HPMN 104, GLR-H 102 issues the PRN message to VMSC/VLR-V 120 to retrieve subscriber 112's MSRN, and then returns the MSRN to the second node. Hence the handling of SRI-SM and SRI messages helps in facilitating mobile communication of subscriber 112 in VPMN 106.
c) Any Time Interrogation (ATI): This allows GLR-H 102 to respond to an ATI query with subscriber 112's current location information (e.g., a cell ID) and states (e.g., subscriber busy), after sending a Provide Subscriber Information (PSI) message to the known VLR address of subscriber 112, in order to provide Location Service (LCS) to subscriber 112. For example, when GLR-H 102 receives the ATI query from a third node (like a VAS application) in HPMN 104, GLR-H 102 sends the PSI to VMSC/VLR-V 120 to retrieve subscriber 112's location information and states, and then returns the retrieved information to the third node.
d) Anytime Subscription Information (ATSI): This allows GLR-H 102 to respond an ATSI query with subscriber 112's information (e.g., forwarding numbers). For example, when GLR-H 102 receives the ATSI query from the third node, GLR-H 102 sends the PSI to VMSC/VLR-V 120 to retrieve subscriber 112's information and states, and then returns the retrieved information to the third node.
e) SRI-GPRS: This allows GLR-H 102 to respond an SRI-GPRS query with an SGSN-V 122 address of subscriber 112, in order to allow GGSN-H 116 to initiate GPRS interactions with SGSN-V 122. For example, when GLR-H 102 receives the SRI-GPRS query from a fourth node (like GGSN-H 116) in HPMN 104, GLR-H 102 returns subscriber 112's SGSN-V 122 address to the fourth node, and then issues a Packet Data Protocol (PDP) notification message to SGSN-V 122 to initiate GPRS interactions.
f) SRI-LCS: This allows GLR-H 102 to respond an SRI-LCS query with VMSC/VLR-V 120 address of subscriber 112, in order to allow a fifth node, e.g., a Gateway Mobile Location Centre (GMLC) in HPMN 104 to retrieve subscriber 112's location information and support from VMSC-V 120. In such a case, when GLR-H 102 receives the SRI-LCS query from the GMLC, GLR-H 102 returns VMSC-V 120 address of subscriber 112 to GMLC. GMLC can then issue a PSL message to VMSC-V 120 to retrieve subscriber 112's location information and support in VMSC-V 120. It will be apparent to a person skilled in the art that the GMLC is a location gateway that enables a network operator to offer Location Based Services (LBS).

In an embodiment of the present invention, by having these messages configured per VPMN, the operator of HPMN 104 uses GLR-H 102 to decide whether to respond to received signaling messages based on application requirements (like handling of call, SMS, GPRS, LCS and LBS) and inter-operator relationships. GLR-H 102 further includes a plug-in module 308 as an additional set of application logic module that applies various set of application logic such as, but not limited to, determining whether to send a LUP message (received from VPMN 106) to HPMN 104, whether to remove or use cached profile of subscriber 112 (i.e. stored at GLR-H 102) to respond to the LUP message, whether to modify subscriber 112's profile prior to sending an ISD message (corresponding to an update message) to VMSC/VLR-V 120 (or SGSN-V 122), and whether to apply any additional VAS. In other words, plug-in module 308 facilitates exchange of one or more signaling messages, such as the LUP message from VMSC/VLR-V 120 and the ISD message from HLR-H 114, between GLR-H 102, HPMN 104, and VPMN 106. It will also be apparent to a person skilled in the art that the system architecture 300 may also include various other network components (not shown in FIG. 3), depending on the architecture under consideration.

Furthermore, in accordance with an embodiment of the present invention, by using plug-in module 308, the operator of HPMN 104 can provide various kinds of VAS to its outbound roamers, based on implementation of GLR-H 102 and requirement(s) of the operator of HPMN 104. In accordance with various embodiments of the present invention, the following are some exemplary sets of application logic that are implemented by plug-in module 308.

### Providing SIMM Services Using an HPMN GLR

In a first set of application logic, GLR-H 102 modifies an ISD message to send a VPMN 106 Mobile Station International Subscriber Directory Number (MSISDN), instead of an HPMN 104 MSISDN to VPMN 106. In an embodiment of the present invention, when the ISD message is received at GLR-H 102 from HPMN 104 (in response to LUP message from VPMN 106 to HPMN 104), GLR-H 102 modifies the ISD message by replacing the HPMN 104 MSISDN with the VPMN 106 MSISDN that corresponds to a local number in VPMN 106, and thereafter sends the modified ISD message to VPMN 106. This type of application, outside of the context of the present invention, is known in the art. (See, for example, U.S. patent application Ser. No. 10/782,681 titled “Providing multiple MSISDN numbers in a mobile device with a single IMSI” filed on Feb. 18, 2004.)

### Providing MIMM Services Using an HPMN GLR

In a second set of application logic, GLR-H 102 modifies a signaling message, such as an ISD-ACK (i.e. a response to the ISD message), to send an HPMN 104 IMSI (i.e. IMSI associated with HPMN 104), instead of a VPMN 106 IMSI (i.e. IMSI associated with VPMN 106) to HPMN 104. In an embodiment of the present invention, when the ISD-ACK message is received at GLR-H 102 from VPMN 106, GLR-H 102 modifies the ISD-ACK message by replacing the HPMN 104 MSISDN with the VPMN 106 MSISDN, and thereafter sends the modified ISD-ACK message to VPMN 106. This second type of application, outside of the context of the present invention, is known in the art. (See, for example, U.S. patent application Ser. No. 10/918,645 entitled “Signaling Gateway with Multiple IMSI with Multiple MSISIDN (MIMM) Service in a Single SIM for Multiple Roaming Partners” filed on Aug. 13, 2004.) Moreover, in the first and second sets of application logic mentioned above, a roaming logic (i.e. a SIMM roaming logic in case of the first set of application logic and a MIMM roaming logic in case of the second set of application logic) is built within GLR-H 102, instead of a separate SS7 node. GLR-H 102 uses the roaming logic to check if any modification in the ISD/ISD-ACK message is required in these two exemplary sets of application logic.

### Removing a Call-Barring-Restriction Using an HPMN GLR

Furthermore, in a third set of application logic, GLR-H 102 modifies (or removes) a call barring parameter from the ISD message prior to sending the ISD message to VPMN 106. In one embodiment of the present invention, when GLR-H 102 receives an ISD message with a Call Barring (CB) parameter (e.g., Operator Determined Barring (ODB) or CB supplementary service) from HPMN 104, GLR-H 102 removes the call barring parameter from the ISD message and sends the modified ISD message to VPMN 106. This allows the operator of HPMN 104 to enable calls of outbound roamers even when calls (outgoing or incoming) are barred for these outbound roamers, without requiring any modification in HLR-H 114. In another embodiment of the present invention, when GLR-H 102 receives an ISD message with a supplementary service status (e.g., call forwarding status) from HPMN 104, GLR-H 102 modifies the supplementary service status to disable call forwarding and sends the modified ISD message to VPMN 106.

### Controlling Late-Call-Forwarding Using an HPMN GLR

In a fourth set of application logic, GLR-H 102 modifies subscriber 112's forwarding numbers to control late call forwarding. In an embodiment of the present invention, GLR-H 102 modifies the ISD message by replacing a Forward-To Number (FTN) with a modified FTN associated with HPMN 104, and then sends the modified FTN in the ISD message to VPMN 106.

### Controlling Roaming Traffic Distribution in a Visited Country Using an HPMN GLR

Furthermore, in a fifth set of application logic, GLR-H 102 caches profile information of subscriber 112 based on pre-defined criteria to control roaming traffic distribution of subscriber 112 in a visiting country of subscriber 112. In an embodiment of the present invention, GLR-H 102 caches profiles of those outbound roamers, which contributes largely to HPMN 104 operator's revenue. The pre-defined criteria includes, but are not limited to, outbound roamers with high usage, GPRS roamers, prepaid roamers, and postpaid roamers. This fifth type of application is known in the art, but outside of the context of the present invention. (See, for example, U.S. patent application Ser. No. 11/819,164 titled “A Network Based Framework for Retaining Inbound Roamers—Inbound Traffic Redirection Based on HLR Errors or VLR Errors” filed on Jun. 25, 2007, and U.S. patent application Ser. No. 11/402,128 titled “Method and Apparatus for Redirection of Inbound Roamer Traffic” filed on Apr. 12, 2006.)

### Traffic Redirection Mechanism to Thwart an Outbound Roamer's Registration at a Non-Preferred VPMN

Additionally, in a sixth set of application logic, GLR-H 102 redirects subscriber 112's roaming traffic to a preferred VPMN when subscriber 112 is attempting to register with a non-preferred VPMN. In an embodiment of the present invention, GLR-H 102 attempts to redirect subscriber 112's roaming traffic from a VPMN ‘X’ to VPMN 106 upon detecting a registration attempt by subscriber 112 at the VPMN ‘X’, where the VPMN ‘X’ is a non-preferred VPMN, whereas VPMN 106 is a preferred VPMN (both with respect to HPMN 104). This redirection is performed by sending registration response reject messages, such as a MAP Cancel Location, a TCAP-abort, a System Failure (SF), an Unexpected Data Value (UDV), a Missing Data (MD), a Roaming Restricted Due to Unsupported Feature (RRDuF), and a Roaming Not Allowed (RNA) from GLR-H 102 to the non-preferred VPMN. Further details about the sixth set of application logic are explained in greater detail in a U.S. Pat. No. 7,072,651 entitled “Method and system for cellular network traffic redirection”, filed on Aug. 5, 2003.

### Countering Anti-Traffic Redirection by a Non-Preferred VPMN using HPMN GLR

Furthermore, in a seventh set of application logic, GLR-H 102 detects the non-preferred VPMN's attempt to redirect subscriber 112's roaming traffic to its own network. In other words, GLR-H 102 detects that the non-preferred VPMN ‘X’ has applied a counter logic against GLR-H 102's sixth logic of traffic redirection. Thereafter, in an eighth set of application logic, GLR-H 102 attempts to redirect subscriber 112's roaming traffic back to VPMN 106 (i.e. the preferred VPMN). Detailed techniques for detecting and redirecting subscriber 112's traffic from a non-preferred VPMN to a preferred one are known, but not in conjunction with the present invention. (See, for example, U.S. patent application Ser. No. 11/374,427 entitled “Method, system and computer program product for countering anti-traffic redirection”, filed on Mar. 14, 2006.)

### Anti-Inbound Traffic Redirection Mechanism to Thwart a Competitor VPMN ITR

In a ninth set of application logic, GLR-H 102 thwarts a competitor VPMN's attempt to redirect subscriber 112's roaming traffic to its network so as to retain subscriber 112 at its preferred network (i.e. VPMN 106). The competitor VPMN is a visited network in the same country as that of VPMN 106 and is a competitor network of VPMN 106, in accordance with an embodiment of the present invention. Using the ninth set of application logic, GLR-H 102 redirects subscriber 112's roaming traffic to VPMN 106, when subscriber 112 leaves VPMN 106 and attempts to register with the competitor VPMN. This ninth type of application is known in the art, but not in the context of the present invention. (See, for example, U.S. patent application Ser. No. 11/375,577 entitled “Method and apparatus by which a home network can detect and counteract visited network inbound network traffic redirection”, filed on Mar. 15, 2006.)

### Using an HPMN GLR to Control Roaming Traffic Distribution

Furthermore, in a tenth set of application logic, GLR-H 102 determines number of registration response reject messages sent to the non-preferred VPMN. This determination is done to control the distribution of subscriber 112's roaming traffic among various VPMNs in a visiting country of subscriber 112. In an embodiment of the present invention, when the operator of HPMN 104 applies the sixth set of application logic using GLR-H 102 to send registration response reject messages to the non-preferred VPMN, it also determines the number of reject messages sent to the non-preferred VPMN. When the number of reject messages sent to the non-preferred VPMN exceeds pre-defined threshold (which may be defined by the operator of HPMN 104), then HPMN 104 stops sending reject messages to the non-preferred VPMN as per the tenth set of set of application logic. Hence the operator of HPMN 104 is able to maintain accurate distribution of its outbound roamers among various VPMNs.

### Handling of the Handset-Stuck Case Using an HPMN GLR

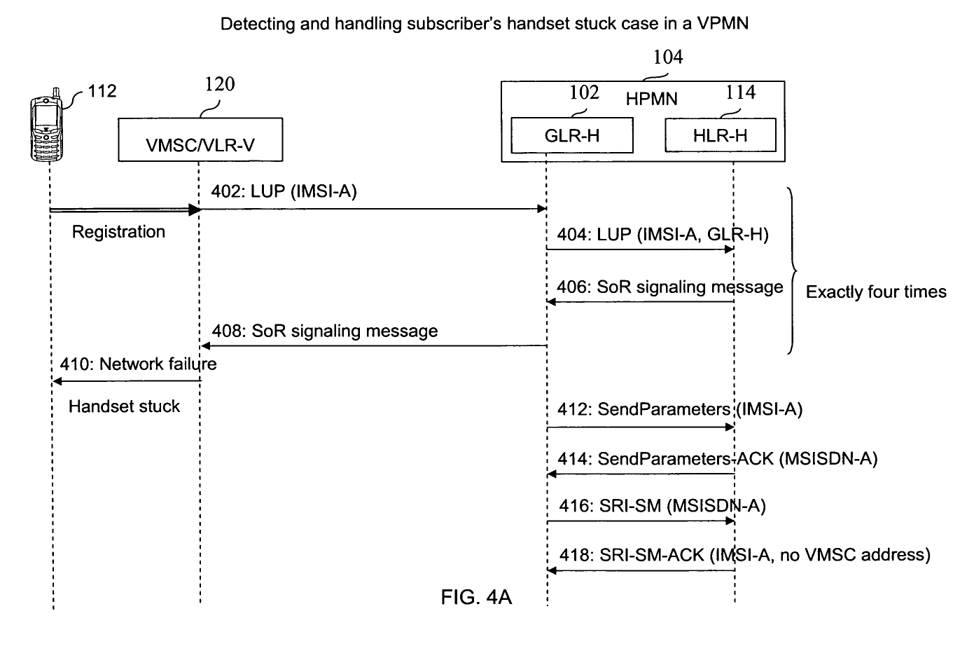

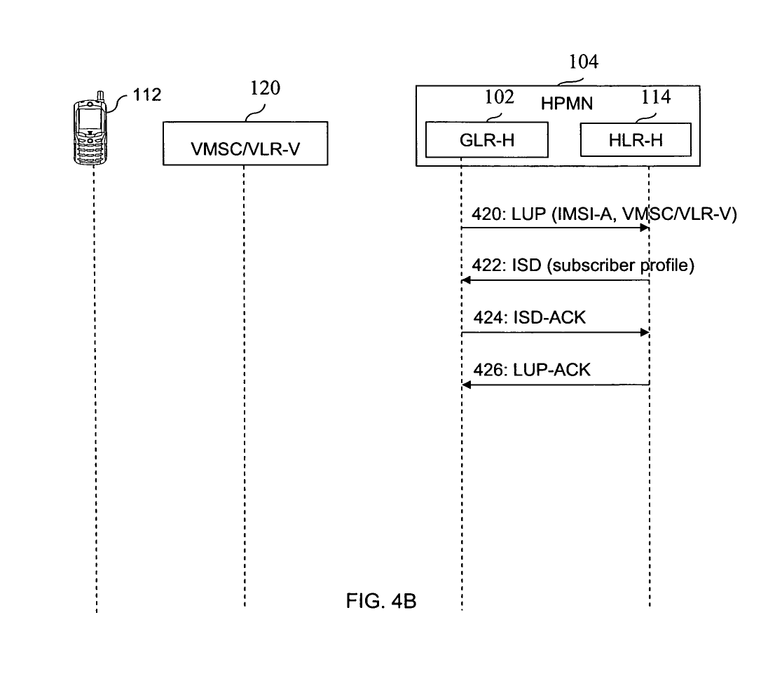

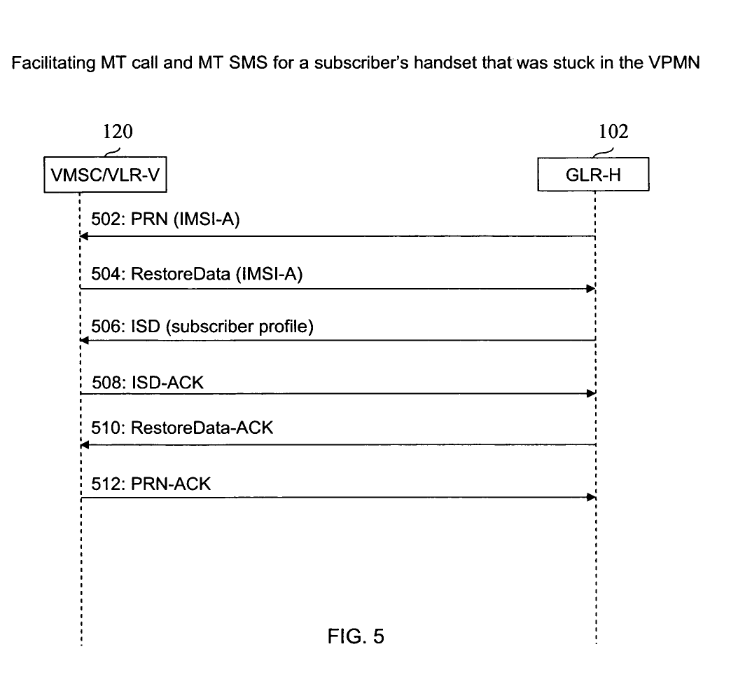

In an eleventh set of application logic, GLR-H 102 detects that subscriber 112's handset is stuck in VPMN 106 due to an incomplete registration process. In an embodiment of the present invention, when subscriber 112 attempts to register with VPMN 106, due to a TR attempt by HPMN 104, subscriber 112's handset gets stuck in VPMN 106, as a result of which the handset is unable to perform any MT activities. In one embodiment of the present invention, since GLR-H 102 is in active mode, it is able to detect handset stuck scenario when: a) handset has made less than four LUP attempts at VPMN 106 (i.e. according to 3GPP 408 and 24008 standards), and b) there are no further LUP attempts by subscriber 112 at VPMN 106 for a pre-defined time interval (which may be configured by the operator of HPMN 104). In another embodiment of the present invention, GLR-H 102 detects handset stuck scenario after HPMN 104 has steered subscriber 112's roaming traffic exactly four times from VPMN 106. Thereafter, GLR-H 102 can handle the handset stuck case by restoring the mobile communication of subscriber 112 in VPMN 106. This handling of stuck handset case and restoring of subscriber 112's mobile communication are described later in detail in conjunction with FIGS. 4A and 4B, and FIG. 5.

### Implementing Traffic Redirection Mechanism Using an HPMN GLR to Create O-CSI and T-CSI for Outbound Roamers

Moreover, GLR-H 102 can create a fake Customized Application for Mobile Enhanced Logic (CAMEL) Subscription Information (CSI) for its outbound roamers when they wish to use CAMEL services in VPMN 106. Hence in a twelfth set of application logic, GLR-H 102 creates CSI for subscriber 112 (as an exemplary case) and responds either to a LUP message from VPMN 106 with nested ISD messages containing the created CSI, or to a LUP-ACK message (corresponding to a registration response message) from VPMN 106 with a standalone ISD message containing the created CSI. In one embodiment of the present invention, an Originating CSI (O-CSI) is created for subscriber 112. In another embodiment of the present invention, a Terminating CSI (T-CSI) is created for subscriber 112. This type of application is known in the art, but not in the context of the present invention. (See, for example, U.S. patent application Ser. No. 11/366,017 entitled “Dynamic generation of CSI for outbound roamers”, filed on Mar. 2, 2006.)

Thus, by integrating one or more sets of application logic explained above with GLR-H 102, the present invention enhances the functionality of GLR-H 102 thus making a stronger business case for HPMN 104 operator to deploy the new and improved GLR-H 102. Moreover, by doing so, the present invention eliminates the need for a separate SS7 node or an SS7 roaming probe. It will be apparent to a person skilled in the art that using the system architecture 300, HPMN 104 operator can develop many more value enhanced roaming services. It will also be apparent to a person skilled in the art that any component in GLR-H 102 can interchangeably perform the function of any other component in GLR-H 102, in order to provide roaming services to outbound roamers of HPMN 104.

As mentioned earlier, GLR-H 102 with enhanced functionalities is also able to handle the outbound roamer's handset stuck case. FIGS. 4A and 4B represent a flow diagram for detecting and handling the stuck handset case, during subscriber 112's registration attempt at VPMN 106, in accordance with an embodiment of the present invention. In a first embodiment of the present invention, when HPMN 104 is attempting to steer subscriber 112 away from VPMN 106 and the registration process is incomplete, subscriber 112's handset gets stuck and GLR-H 102 suspects this stuck condition. GLR-H 102 detects this stuck case by observing exactly four Steering of Roaming (SoR) signaling messages, e.g., the registration response reject message from HPMN 104. It will be apparent to a person skilled in the art that GLR-H 102 deals with the handset stuck case with a similar technique for VPMN 106 or any other VPMN.

In this first embodiment, at step 402, when VMSC/VLR-V 120 receives a LUP message from subscriber 112's handset, VMSC/VLR-V 120 sends the LUP message on IMSI-A to GLR-H 102. Thereafter, at step 404, GLR-H 102 uses GLR-H 102 GT (from the pool of GTs), corresponding to VLR-V 120, to interact with HPMN 104, and sends the LUP message on the IMSI-A along with GLR-H 102 GT (emulating HPMN 104 with GLR-H 102 as VLR of subscriber 112) to HPMN 104, after modifying CgPA as GLR-H 102 GT. In an embodiment of the present invention, HPMN 104 determines VPMN 106 as a non-preferred VPMN and hence applies SoR against VPMN 106. Hence at step 406, HPMN 104 issues the registration response reject message to GLR-H 102. Furthermore, at step 408, GLR-H 102 relays the registration response reject message to VMSC/VLR-V 120, after modifying CgPA as the GLR-H 102 GT (emulating VMSC/VLR-V 120 with GLR-H 102 as HLR of subscriber 112 this time) and CdPA as VMSC/VLR-V 120. It will be apparent to a person skilled in the art that profile exchange messages, such as ISD and ISD-ACK (not shown in FIGS. 4A and 4B) are also exchanged during this LUP process of subscriber 112 at VPMN 106. As per the 3GPP 408 and 24.008 standards, subscriber 112 makes a total of four registration attempts at VMSC/VLR-V 114 and gets a LUP reject message each time (steps 402 to 408).

Now, since LUP reject message is returned due to SoR attempt from HPMN 104, VMSC/VLR-V 120 sends a network failure message indicating failure of subscriber 112's LUP attempt at VPMN 106, to subscriber 112's handset, at step 410. After the failure of the fourth registration attempt by subscriber 112 at VPMN 106, subscriber 112's handset may get stuck in VPMN 106. Now, in order to recover subscriber 112 from this stuck case, the operator of HPMN 104 configures GLR-H 102 to issue a MAP SendParameters message on the IMSI-A to HLR-H 114, at step 412. Thereafter, at step 414, HLR-H 114 returns MSISDN-A to GLR-H 102 in a MAP SendParameters-ACK message. It will be apparent to a person skilled in the art that the MAP Sendparameters message need not be sent in case GLR-H 102 has already cached MSISDN-A and IMSI-A mapping either from an earlier successful LUP process at VPMN 106 or a prior SendParameters transaction with HLR-H 114.

In order to further confirm the handset stuck case, at step 416, GLR-H 102 sends SRI-SM message to HLR-H 114 to check if subscriber 112 has registered with another VPMN. Thereafter, at step 418, HLR-H 114 returns an SRI-SM-ACK message on the IMSI-A without any VMSC address to GLR-H 102, confirming that subscriber 112's handset is stuck at VPMN 106. However in one embodiment of the present invention, when VMSC address returned is that of a competitor VPMN (which is competitor of the VPMN 106); GLR-H 102 does not perform any further action to handle this stuck case. In another embodiment of the present invention, when subscriber 112's handset is stuck in the competitor VPMN, GLR-H 102 recovers subscriber 112 based on percentage control or threshold control per VPMN, or threshold control per outbound roamer of HPMN 104. In an exemplary case, GLR-H 102 does not recover such a stuck subscriber for a pre-defined number of times (configurable by the operator of HPMN 104) within a pre-defined time interval (which is also HPMN 104 operator configurable). In another exemplary case, GLR-H 102 does not handle such cases for more than an X % of outbound roamers associated with HPMN 104.

In another embodiment of the present invention, subscriber 112 may also go back to his HPMN 104 (or a new VPMN) instead of being stuck at VPMN 106. In such a case GLR-H 102 issues a fake LUP message with its own GT as VMSC/VLR address of subscriber 112 to HPMN 104, upon detecting the LUP reject message from HPMN 104 (i.e. at step 406) for the first time for a non-preferred VPMN (i.e. VPMN 106). Now, when GLR-H 102 sends the SRI-SM message to HLR-H 114 (i.e. at step 416), GLR-H 102 determines whether the returned VMSC/VLR address is GLR-H 102's own GT. If so, GLR-H 102 confirms that subscriber 112's handset is stuck at VPMN 106. Otherwise, in case the VMSC/VLR address is different, subscriber 112's handset is determined to have either gone back to HPMN 104 or the new VPMN.

Alternatively, when no VMSC address is received in the SRI-SM-ACK message and GLR-H 102 is sure that the handset is stuck, the operator of HPMN 104 configures GLR-H 102 to send another LUP message on the IMSI-A along with the last known VLR location of subscriber 112 (i.e. VMSC/VLR-V 120) to HLR-H 114, at step 420. This is done to restore VMSC/VLR-V 120 as the location of subscriber 112 at HLR-H 114, in case no VMSC address is returned from the SRI-SM-ACK message. Thereafter, at steps 422 and 424, GLR-H 102 and HLR-H 114 exchange subscriber 112's profile information (i.e. exchange ISD and ISD-ACK messages). Finally, at step 426, HLR-H 114 returns a LUP-ACK message, to GLR-H 102 (in response to LUP sent at step 420), indicating successful registration of subscriber 112 at VPMN 106.

Unlike the first embodiment explained above, in a second embodiment of the present invention, GLR-H 102 detects the stuck condition in less than four LUP attempts from VMSC/VLR-V 120. In other words, GLR-H 102 observes only three (or less) LUP attempts at VPMN 106, and does not observe fourth LUP attempt at the same network (i.e. VPMN 106). Steps 402 to 408 describing LUP process of subscriber 112 at VPMN 106 remains same for the second embodiment, however, in this embodiment, VMSC/VLR-V 120 sends a network failure message, at step 410, to subscriber 112's handset in less than four LUP attempts at VPMN 106. In addition, steps 412 to 418 describing the retrieval of MSISDN-A and subscriber 112's location information are not required and hence are not performed, since GLR-H 102 already has confirmation about the handset stuck condition. Also, steps 420 to 426 that describe a separate LUP process of subscriber 112, initiated by GLR-H 102, remains same even in the second embodiment.

### Restoring an Outbound Roamer's Mobile Communications when Handset is Stuck at VPMN

Although subscriber 112 is able to initiate mobile activities (e.g., MO calls and SMS), he is unable to receive calls and SMS, and avail data capabilities service, once stuck in VPMN 106. Hence in order to completely facilitate mobile communication of subscriber 112 whose handset is stuck during its registration attempt(s) at VPMN 106, MT activities for this subscriber needs to be restored. FIG. 5 represents a flow diagram for restoring MT call, MT SMS, and data capability of subscriber 112, when subscriber 112's handset is stuck at VPMN 106, in accordance with an embodiment of the present invention. FIG. 5 is applicable for both of the above described first and second embodiments for handset stuck case. In order to restore subscriber 112's MT activities, the operator of HPMN 104 configures GLR-H 102 to issue MAP messages, such as a PRN, an ISD, and a RestoreData-ACK to VMSC/VLR-V 120. At step 502, GLR-H 102 issues a PRN message on the IMSI-A to VMSC/VLR-V 120. Thereafter, at step 504, VMSC/VLR-V 120 returns a RestoreData message on the IMSI-A to GLR-H 102 since VMSC/VLR-V 120 has no record of subscriber 112. GLR-H 102 then retrieves the cached subscriber 112's profile information from its database (i.e. profile DB 304 in system 300), and sends the retrieved profile information in an ISD message to VMSC/VLR-V 120, at step 506. Thereafter, at step 508, VMSC/VLR-V 120 returns an ISD-ACK message to GLR-H 102, which at step 510 sends a RestoreData-ACK message to VMSC/VLR-V 120. Finally, at step 512, GLR-H 102 sends a PRN-ACK message to VMSC/VLR-V 120, thereby facilitating mobile communication of subscriber 112 in VPMN 106.

### Servicing 3G Outbound Roamers Using an HPMN GLR

Furthermore, some network operators may like to provide roaming services to its outbound roamers having 3G capabilities. Presently, there exist numerous 3G network operators; however, most of them are able to maintain only a 2G roaming agreement as upgrading to 3G roaming agreements requires longer time in testing and billing process checks. It will be apparent to a person skilled in the art that although a handset having 3G capabilities usually first searches for a 3G network; however, most of the existing 3G capable handsets have backward compatibility, i.e., they have both 3G and 2G support. Hence in case VPMN 106 has no 3G roaming agreement with HPMN 104 (but has 2G roaming agreement), subscriber 112 should ideally fail to register with 3G support at VPMN 106. However some VPMN operators may implement fake logic so as to allow inbound roamers from HPMN 104 to register with 3G capabilities at their respective networks even when these VPMN operators have no 3G roaming agreement with HPMN 104. Moreover, these VPMN operators may charge these roamers at 2G tariff even though these roamers make use of these VPMNs' 3G support.

### Blocking 3G Services Using an HPMN GLR

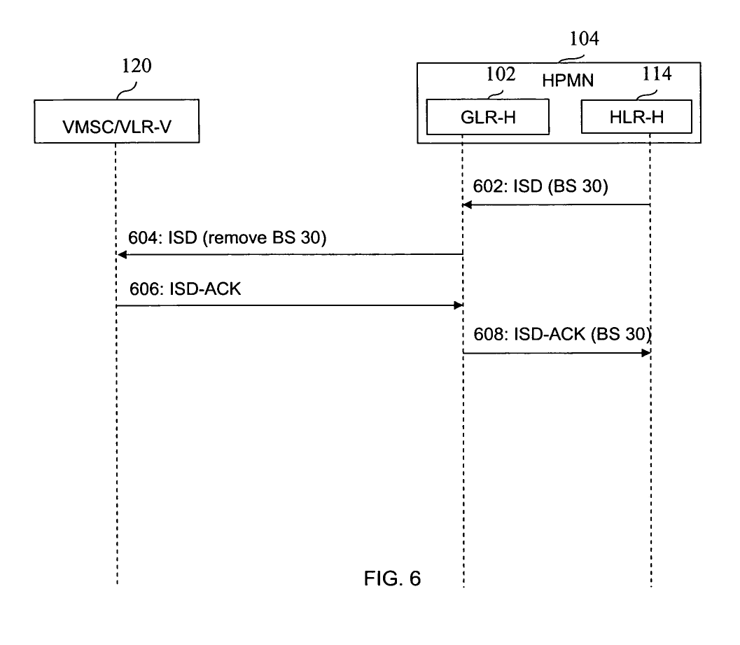

In one embodiment of the present invention, the operator of HPMN 104 may not want its outbound roamers to avail some 3G services in such VPMN networks. The present invention allows conversion of various MAP messages corresponding to a first set of signaling messages such as, but not limited to, LUP, Send Authentication Information (SAI) and ISD containing one or more 3G parameters, to respective 2G MAP messages containing 2G parameters. In other words, GLR-H 102 modifies these signaling messages exchanged between HPMN 104 and VPMN 106, by removing one or more 3G parameters from these MAP messages, when HPMN 104 has no 3G roaming agreement, but a 2G roaming agreement with VPMN 106. The operator of HPMN 104 may not prefer modifying LUP and SAI messages to remove 3G parameter. Although, most of the HPMN operators may want to modify the ISD message to restrict 3G roaming services in such a case. FIG. 6 represents a flow diagram for removing a 3G parameter using GLR-H 102 when HPMN 104 has no 3G, but 2G roaming agreement with VPMN 106, in accordance with an embodiment of the present invention. The operator of HPMN 104 may want to block video calling (a 3G service) of subscriber 112. Thus, when subscriber 112 makes a 3G attempt to register with VPMN 106, HLR-H 114 receives a 2G LUP message from GLR-H 102, which is received from VPMN 106. Thereafter, at step 602, when GLR-H 102 receives a Bearer Services (BS) 30 parameter (which is a 3G parameter) in an ISD message from HLR-H 114, GLR-H 102 removes the BS 30 parameter and sends the modified ISD message to VMSC/VLR-V 120, at step 604. GLR-H 102 also modifies CgPA to the GLR-H 102 GT (corresponding to VLR-V 120) prior to relaying the ISD message to VMSC/VLR-V 120, in accordance with an embodiment of the present invention. Further, at step 606, VMSC/VLR-V 120 sends an ISD-ACK message to GLR-H 102, which at step 608 relays it to HLR-H 114 with an indication that BS 30 is not supported. Hence incoming video call will not be attempted in HPMN 104. Once subscriber 112 is successfully registered with VPMN 106, he can thereafter use other 3G capabilities offered by the operator of VPMN 106, while he is roaming in VPMN 106.

In accordance with an embodiment of the present invention, when subscriber 112 uses GPRS services while roaming in VPMN 106, VMSC/VLR-V 120 is replaced with SGSN-V 122 for handling signaling of subscriber 112. Hence one or more embodiments that are explained above for GSM outbound roamers are also applicable for GPRS outbound roamers.

### Detecting a VPMN GLR Using an HPMN GLR

Furthermore, the operator of HPMN 104 may want to optimize steering of its outbound roamers' roaming traffic, based on the knowledge that VPMN 106 is also performing steering. This can be achieved by using GLR-H 102 (with any monitoring mechanism, active or passive) to detect whether VPMN 106 is deploying an add-on SS7 node. This add-on SS7 node corresponds to a new GLR module deployed at VPMN 106, in accordance with an embodiment of the present invention. Alternatively, it may be any other component (in VPMN 106) that is attempting to redirect roamers to its own network. In case the new GLR module is using a single GT in all LUP transactions by subscriber 112 while roaming in VPMN 106, then HPMN 104 can conclude that VPMN 106 is deploying the new GLR module. However in case VPMN 106 is using multiple GTs for the new GLR module, then to detect presence of the new GLR module in VPMN 106, HPMN 104 needs to possess a CAMEL agreement with VPMN 106. In this case, GLR-H 102 monitors roaming link between HPMN 104 and VPMN 106 for exchange of signaling messages such as, but not limited to, LUP and CAMEL Initial Detection Point (IDP) messages. Since, the new GLR module does not modify CAMEL messages that are intended for HPMN 104, GLR-H 102 can check whether the LUP attempt by outbound roamer at VPMN 106 contains the same VMSC/VLR location address as that received in the CAMEL IDP message. In case the VMSC/VLR addresses received in these two messages are different, HPMN 104 can suspect presence of the new GLR module in VPMN 106.

In an embodiment of the present invention, when VPMN 106 possess no CAMEL agreement with HPMN 104 and is using multiple GTs for its new GLR module, the operator of HPMN 104 statistically determines the presence of the new GLR module in VPMN 106 when subscriber 112's registration attempts at VPMN 106 always present the same GT till its departure from VPMN 106.

### Sharing an HPMN GLR by Different HPMN Operators

In another embodiment of the present invention, HPMN 104 operator may also want to share GLR-H 102 with some other HPMN operators, in order to bring down the cost of deploying and maintaining respective GLRs in each of the respective HPMN operators' network. Another reason could be that sharing HPMN operators may want their outbound subscribers to avail roaming services while roaming in VPMN 106 even when some (or all) of these HPMN operators do not possess roaming agreement with VPMN 106. This will be described later in the context of the present invention. In an embodiment of the present invention, the shared GLR is assigned a GT for each HLR per partner HPMN. In an embodiment of the present invention, the shared GLR is centrally deployed at HPMN 104 (i.e. acts as GLR-H 102). In another embodiment of the present invention, the shared GLR is deployed at any partner HPMN. In yet another embodiment of the present invention, an international SS7 carrier or a common carrier deploys the shared GLR at a common hosting location for partner HPMNs. Various embodiments of the present invention, described hereinafter for shared GLR, assume that the shared GLR is deployed in HPMN 104 as GLR-H 102. In addition, GLR-H 102 is defined per partner HPMN, in accordance with an embodiment of the present invention. This means that various sets of application logic, applied by plug-in module 308 that were earlier defined for all outbound roamers of HPMN 104, will now be defined for each partner HPMN. Also, each partner HPMN configures and defines one or more signaling messages that are defined per VPMN and are handled by GLR-H 102. Similarly, each partner HPMN control various CAMEL services that are defined for the outbound roamers.

In a first embodiment of the present invention, each partner HPMN has a Gateway Mobile Switching Center (GMSC) associated with it. These GMSCs are hereinafter interchangeably referred to as one or more gateway switching centers. The GMSCs communicate with GLR-H 102 via a leased line connection (or any other dedicated connection). The leased line connection is required to avoid GT routing and use of prepaid STP (both of which otherwise would have been applicable), for routing all signaling messages, in addition to providing secured exchange of all signaling messages. In a second embodiment of the present invention, each partner HPMN deploys an add-on SS7 node in its network. These nodes communicate with GLR-H 102 by exchanging all SSCP signaling messages, using an encapsulation/de-capsulation technique. Now, upon receiving SCCP messages from partner HPMNs, GLR-H 102 needs to de-capsulate such messages before processing any further. This technique of encapsulation of SCCP messages by partner HPMNs and then de-capsulation of such messages by GLR-H 102 is referred to as encapsulation/de-capsulation technique. It will be apparent to a person skilled in the art the second embodiment does not require any leased line connection.

Furthermore, in a third embodiment of the present invention, each partner HPMN has a roaming STP associated with its network. For example, STP-H 128 is the roaming STP in HPMN 104. These one or more roaming STPs communicate with GLR-H 102, as they are configured to redirect all signaling messages of subscribers that are associated with their respective HPMNs, destined for VPMN 106, to an international SPC associated with GLR-H 102. This embodiment does not require any leased line or add-on SS7 nodes in any partner HPMN. Alternatively, in a fourth embodiment of the present invention, these roaming STPs communicate with GLR-H 102 by exchanging all signaling messages over an IP network, when GLR-H 102 supports a Stream Control Transmission Protocol (SCTP) and an MTP2 User Peer-to-peer Adaptation Layer (M2PA) protocol. This embodiment also requires each of these roaming STPs to support a Signaling Transport (SIGTRAN), the SCTP and the M2PA protocols.

In accordance with a fifth embodiment of the present invention, these roaming STPs communicate with GLR-H 102, using a prefix GT approach. This is achieved by configuring each of these roaming STPs to redirect all signaling messages with the pre-defined prefixed GT (configured by each partner HPMN) to GLR-H 102. In other words, the roaming STPs add the pre-defined prefix to a GT of an original CdPA. The original CdPA in such case corresponds to an address of VPMN 106. Usually, the standard limit for the length of the SCCP CdPA is limited to 15 digits. Although the length may be extended to 18 digits, some SCCP carriers follow the standard limit length of the CdPA. In order to overcome the problem of limited number of digits for the SCCP CdPA, partner HPMNs may use an alias GT approach, where each partner HPMN configures its respective STP to replace a first GT (corresponding to the GT of original CdPA) with a second GT that corresponds to GLR-H 102. This allows redirecting all signaling messages with the second GT to GLR-H 102. This technique is based on one-to-one correspondence where each roaming STP communicates with GLR-H 102 for each of the partner HPMN.

In another embodiment of the present invention, the shared GLR is allocated a GT of an HPMN that is elected to represent the group of partner HPMNs when an outbound roamer associated with any of the partner HPMN of this group registers with VPMN 106. The elected HPMN corresponds to a sponsor HPMN that has a roaming agreement with VPMN 106, whereas other partner HPMNs function as sponsored HPMNs, which piggyback on roaming relationships of the sponsor HPMN for routing their signaling messages to VPMN 106. Hence these partner HPMNs communicate with VPMN 106 via the shared GLR, without following the complex route of having bilateral roaming agreements with each of the roaming partners of the sponsor HPMN. This sponsor HPMN may either be from the group of partner HPMNs. or a new HPMN that is not a part of the group of partner HPMNs. In the sponsor HPMN case, HPMN 104 always perceives as if its outbound roamer is registered at the sponsor HPMN (deploying the shared GLR, i.e., GLR-H 102), irrespective of its actual registration location. In an embodiment of the present invention, when subscriber 112 having a dual IMSI SIM (i.e., two IMSIs, a first IMSI-X of a sponsor HPMN-X and second IMSI-A of HPMN 104) attempts to register at VPMN 106 using the IMSI-X, a LUP message from VMSC/VLR-V 120 is relayed to HLR-H 114 via the shared GLR. Since, the received LUP message contains the IMSI of the sponsor HPMN that has a roaming agreement with both HPMN 104 and VPMN 106; HLR-H 114 allows subscriber 112 to register at VPMN 106 even when VPMN 106 does not have roaming agreement with HPMN 104.

In addition, the shared GLR (or GLR-H 102) described above can also work as an integrated function within an STP (national or international) or as an independent SS7 node. It will be apparent to a person skilled in the art that roaming services can be provided to outbound roamers using other technologies such as, but not limited to, VoIP, WiFi, 2G, 3G, and inter-standard roaming. For example, a 3G roaming subscriber traveling to a VPMN may like to avail roaming services similar to the ones he receives in his HPMN. To support these variations, GLR-H 102 will have a separate SS7 and network interfaces corresponding to both the VPMN and HPMN networks. It will also be apparent to a person skilled in the art that these two interfaces in different directions may not have to be the same technologies. In addition, there could be multiple types of interfaces in both directions.

An HPMN operator uses one or more embodiments of the present invention to provide roaming services to its outbound roamers, while they are registered with a VPMN. The overall cost associated with deploying an enhanced functionality GLR is less; moreover, the GLR can provide various VASs to the outbound roamers of HPMN when they register at HPMN's preferred VPMN network. This also allows the HPMN operator to entice more outbound roamers to register at its preferred VPMN network. Also, reduction in the cost of deploying and maintaining additional SS7 nodes to the existing network eventually maximizes roaming revenues for the HPMN operator. Furthermore, the HPMN operator is able to adjust its roaming traffic of outbound roamers across various VPMNs in the outbound roamers' visiting country. Moreover, various HPMN operators can also share the GLR making the deployment even more cost effective, since a single node is able to serve a number of operators allowing them to increase their roaming revenues. The present invention also ensures that outbound subscribers' roaming traffic is not affected in case GLR goes down, hence ensuring no loss of roaming revenue to HPMN operator.

The present invention can take the form of an entirely hardware embodiment, an entirely software embodiment, or an embodiment containing both hardware and software elements. In accordance with an embodiment of the present invention, software, including but not limited to, firmware, resident software, and microcode, implements the present invention.

Furthermore, the present invention can take the form of a computer program product, accessible from a computer-usable or computer-readable medium providing program code for use by, or in connection with, a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CDROM), compact disk-read/write (CD-R/W) and Digital Versatile Disk (DVD).

A computer usable medium provided herein includes a computer usable program code, which when executed, provides providing roaming services to a subscriber, associated with an HPMN, in a VPMN. The computer program product further includes a computer usable program code for allocating to a GLR that is associated with the HPMN, a pool of GTs corresponding to one or more HLRs associated with the HPMN. The computer program product further includes a computer usable program code for facilitating mobile communication of the subscriber in the VPMN, while he is registered with the VPMN.

The components of present system described above include any combination of computing components and devices operating together. The components of the present system can also be components or subsystems within a larger computer system or network. The present system components can also be coupled with any number of other components (not shown), such as other buses, controllers, memory devices, and data input/output devices, in any number of combinations. In addition, any number or combination of other processor-based components may be carrying out the functions of the present system.

It should be noted that the various components disclosed herein may be described using computer aided design tools and/or expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but may not be limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, it covers all of the following interpretations: any of the items in the list, all of the items in the list and any combination of the items in the list.

The above description of illustrated embodiments of the present system is not intended to be exhaustive or to limit the present system to the precise form disclosed. While specific embodiments of, and examples for, the present system are described herein for illustrative purposes, various equivalent modifications are possible within the scope of the present system, as those skilled in the art will recognize. The teachings of the present system provided herein can be applied to other processing systems and methods. They may not be limited to the systems and methods described above.

The elements and acts of the various embodiments described above can be combined to provide further embodiments. These and other changes can be made in light of the above detailed description.

### Other Variations

Provided above for the edification of those of ordinary skill in the art, and not as a limitation on the scope of the present invention, are detailed illustrations of a scheme for providing roaming services to a subscriber, associated with an HPMN, roaming in a VPMN. Numerous variations and modifications within the spirit of the present invention will of course occur to those of ordinary skill in the art in view of the embodiments that have been disclosed. For example, the present invention is implemented primarily from the point of view of GSM mobile networks as described in the embodiments. However the present invention may also be effectively implemented on GPRS, 3G, CDMA, WCDMA, WiMax etc., or any other network of common carrier telecommunications in which end users are normally configured to operate within a “home” network to which they normally subscribe, but have the capability of also operating on other neighboring networks, which may even be across international borders.

The examples under the system of present invention detailed in the illustrative examples contained herein are described using terms and constructs drawn largely from GSM mobile telephony infrastructure. However use of these examples should not be interpreted as limiting the present invention to those media. The system and method can be of use and provided through any type of telecommunications medium, including without limitation: (i) any mobile telephony network including without limitation GSM, 3GSM, 3G, CDMA, WCDMA or GPRS, satellite phones or other mobile telephone networks or systems; (ii) any so-called WiFi apparatus normally used in a home or subscribed network, but also configured for use on a visited or non-home or non-accustomed network, including apparatus not dedicated to telecommunications such as personal computers, Palm-type or Windows Mobile devices; (iii) an entertainment console platform such as Sony Playstation, PSP or other apparatus that are capable of sending and receiving telecommunications over home or non-home networks, or even (iv) fixed-line devices made for receiving communications, but capable of deployment in numerous locations while preserving a persistent subscriber id such as the eye2eye devices from Dlink; or telecommunications equipment meant for voice over IP communications such as those provided by Vonage or Packet8.

In describing certain embodiments of the system under the present invention, this specification follows the path of a telecommunications call, from a calling party to a called party. For the avoidance of doubt, such a call can be a normal voice call, in which the subscriber telecommunications equipment is also capable of visual, audiovisual or motion-picture display. Alternatively, those devices or calls can be for text, video, pictures or other communicated data.

In the foregoing specification, specific embodiments of the present invention have been described. However one of ordinary skill in the art will appreciate that various modifications and changes can be made without departing from the scope of the present invention as set forth in the claims below. Accordingly, the specification and the figures are to be regarded in an illustrative rather than a restrictive sense, and all such modifications are intended to be included within the scope of present invention. The benefits, advantages, solutions to problems, and any element(s) that may cause any benefit, advantage, or solution to occur, or to become more pronounced, are not to be construed as a critical, required, or essential feature or element of any or all of the claims.

APPENDIX

| Acronym | Description |
|---|---|
| 3G | Third Generation of mobile |
| 3GPP | Third Generation Partnership Project |
| APN | Access Point Name |
| APN-H | HPMN APN |
| APN-V | VPMN APN |
| ATI | Any Time Interrogation |
| ATSI | Anytime Subscription Information |
| CAMEL | Customized Application for Mobile Enhanced Logic |
| CAP | Camel Application Part |
| CB | Call Barring |
| CdPA | Called Party Address |
| CgPA | Calling Party Address |
| CSI | Camel Subscription Information |
| DNS | Domain Name Server |
| FTN | Forward-To Number |
| GGSN | Gateway GPRS Support Node |
| GGSN-H | GGSN in HPMN |
| GGSN-V | GGSN in VPMN |
| GLR | Gateway Location Register |
| GMLC | Gateway Mobile Location Centre |
| GMSC | Gateway MSC |
| GMSC-H | GMSC in HPMN |
| GMSC-V | GMSC in VPMN |
| GPRS | General Packet Radio System |
| GSM | Global System for Mobile |
| GT | Global Title |
| GTP | GPRS Tunneling Protocol |
| HLR | Home Location Register |
| HLR-H | HPMN HLR |
| HPMN | Home Public Mobile Network |
| IDP | Initial Detection Point IN/CAP message |
| IM-GSN | Intermediate GSN |
| IM-MSC | Intermediate Mobile Switching Center |
| IMSI | International Mobile Subscriber Identity |
| IP | Internet Protocol |
| ISD | MAP Insert Subscriber Data |
| ISTP | International STP |
| ISTP-V | ISTP connected to VPMN STP |
| ISTP-H | ISTP connected to HPMN STP |
| ITR | Inbound Traffic Redirection |
| LCS | Location Service |
| LUP | MAP Location Update |
| M2PA | MTP2 User Peer-to-peer Adaptation Layer |
| MAP | Mobile Application Part |
| MD | Missing Data |
| MGT | Mobile Global Title |
| MO | Mobile Originated |
| MIMM | Multiple IMSI Multiple MSISDN |
| MSC | Mobile Switching Center |
| MSISDN | Mobile Station International Subscriber Directory Number |
| MSRN | Mobile Station Roaming Number |
| MT | Mobile Terminated |
| O-CSI | Originating CAMEL Subscription Information |
| ODB | Operator Determined Barring |
| PDP | Packet Data Protocol |
| PRN | MAP Provide Roaming Number |
| PSL | Provide Subscriber Location |
| PSI | MAP Provide Subscriber Information |
| RNA | Roaming Not Allowed |
| RRDuF | Roaming Restricted Due to unsupported Feature |
| SAI | Send Authentication Information |
| SCCP | Signaling Connection Control part |
| SCP | Signaling Control Point |
| SCTP | Stream Control Transmission Protocol |
| SF | System Failure |
| SG | Signaling Gateway |
| SGSN | Serving GPRS Support Node |
| SGSN-H | HPMN SGSN |
| SGSN-V | VPMN SGSN |
| SIGTRAN | Signaling Transport |
| SIM | Subscriber Identity Module |
| SMS | Short Message Service |
| SMS-GMSC | Short Message Service GMSC |
| SMSC | Short Message Service Center |
| SIMM | Single IMSI Multiple MSISDN |
| SPC | Signal Point Code |
| SRI | MAP Send Routing Information |
| SRI-LCS | MAP Send Routing Information for Location Service |
| SRI-SM | MAP Send Routing Information for Short Message |
| SRI-GPRS | MAP Send Routing Information for GPRS |
| SS | Supplementary Services |
| SS7 | Signaling System #7 |
| SSN | Sub System Number |
| STP | Signal Transfer Point |
| STP-V | VPMN STP |
| STP-H | HPMN STP |
| TCAP | Transaction Capabilities Application Part |
| T-CSI | Terminating CAMEL Service Information |
| TR | Traffic Redirection |
| UMTS | Universal Mobile Telecommunications System |
| UDV | Unexpected Data Value |
| VAS | Value Added Service |
| VHE | Virtual Home Environment |
| VLR | Visited Location Register |
| VLR-V | VPMN VLR |
| VMSC | Visited Mobile Switching Center |
| VMSC-V | VPMN VMSC |
| VPMN | Visited Public Mobile Network |

### Technical References (the Entirety of Each of which is Incorporated by Reference Herein)

### GSM 902 on MAP specification

### Digital cellular telecommunications system (Phase 2+)

### Mobile Application Part (MAP) Specification

### (3GPP TS 09.02 version 7.9.0 Release 1998)

### GSM 340 on SMS

### Digital cellular telecommunications system (Phase 2+)

### Technical realization of the Short Message Service (SMS)

### (GSM 03.40 version 7.4.0 Release 1998)

### GSM 23.119 Gateway Location Register (GLR)

### GSM 23.120 MAP specification for GLR

### GSM 320 Security related network functions

### GSM 360 on GPRS

### GSM 23.060 on GPRS R99

### GSM 960 on GPRS GTP 0

### GSM 29.060 on GPRS GTP 1

### GSM 378 on CAMEL,

### GSM 978 on CAMEL Application Protocol,

### GSM 379 on CAMEL Support of Optimal Routing (SOR),

### GSM 318 on CAMEL Basic Call Handling

### ITU-T Recommendation Q.1214 (1995), Distributed functional plane for intelligent network CS-1,

### ITU-T Recommendation Q.1218 (1995), Interface Recommendation for intelligent network CS-1,

### ITU-T Recommendation Q.762 (1999), Signaling system No. 7—ISDN user part general functions of messages and signals,

### ITU-T Recommendation Q.763 (1999), Signaling system No. 7—ISDN user part formats and codes,

### ITU-T Recommendation Q.764 (1999), Signaling system No. 7—ISDN user part signaling procedures,

### ITU-T Recommendation Q.765 (1998), Signaling system No. 7—Application transport mechanism,

### ITU-T Recommendation Q.766 (1993), Performance objectives in the integrated services digital network application,

ITU-T Recommendation Q.769.1 (1999), Signaling system No. 7—ISDN user part enhancements for the support of Number Portability

I claim:

1. A method for providing roaming services to a subscriber of a Home Public Mobile Network (HPMN), the subscriber being registered with a Visited Public Mobile Network (VPMN), the HPMN having one or more Home Location Registers (HLRs) and an associated Gateway Location Register (GLR), the method comprising:
allocating a pool of Global Titles (GTs), the pool of GTs including a plurality of GTs, to the GLR, the pool of GTs corresponding to the one or more HLRs; and
facilitating, via the GLR, a mobile communication of the subscriber;
wherein more than one selected from the plurality of GTs from the pool of GTs is allocated to the GLR; and
wherein the GLR communicates with each one of the one or more HLRs via a different one selected from the plurality of the GTs in the pool.

2. The method of claim 1, the HPMN having an associated Signal Transfer Point (STP), wherein the STP is configured to redirect to the GLR one selected from a group consisting of: signaling messages corresponding to the subscriber, and different blocks of E.214 signaling messages corresponding to the subscriber.

3. The method of claim 2, wherein one of the one or more HLRs stores the subscriber profile information; and
wherein, upon detecting a failure of the GLR, the STP is configured to route to the one of the one or more HLRs to one selected from a group consisting of: all the signaling messages, and the different blocks of the E.214 signaling messages corresponding to the subscriber.

4. The method of claim 1, each of the one or more HLRs having one or more associated subscribers, wherein a RESET of one of the one or more HLRs affects mobile communications of the one or more subscribers associated with the one HLR.

5. The method of claim 1, wherein the GLR is coupled to a plug-in module that facilitates exchange of signaling messages between the GLR and the HPMN, and between the GLR and the VPMN, by applying application logic to the one or more signaling messages.

6. The method of claim 5, wherein applying the application logic includes one selected from a group consisting of: modifying an update message to send a VPMN Mobile Station International Subscriber Directory Number (MSISDN), instead of an HPMN MSISDN to the VPMN; modifying a signaling message to send an HPMN International Mobile Subscriber Identity (IMSI), instead of a VPMN IMSI to the HPMN; modifying a call barring parameter from the update message prior to sending the update message to the VPMN; sending a modified Forward-To Number (FTN) associated with the HPMN in the update message to the VPMN to control late call forwarding; caching profile information of the subscriber based on pre-defined criteria to control distribution of roaming traffic of the subscriber in a visiting country of the subscriber; redirecting roaming traffic of the subscriber to a preferred VPMN when the subscriber is attempting to register with a non-preferred VPMN; detecting an attempt by a non-preferred VPMN to redirect roaming traffic of the subscriber to the network of the non-preferred VPMN; redirecting the subscriber's roaming traffic to a preferred VPMN upon detecting an attempt by a non-preferred VPMN to redirect the subscriber's roaming traffic to the network of the non-preferred VPMN; redirecting roaming traffic of the subscriber to the VPMN in order to thwart a competitor VPMN's attempt to retain the subscriber in the network of the competitor VPMN, when the subscriber attempts to register with the competitor VPMN; determining a number of registration response reject messages corresponding to a non-preferred VPMN to control the distribution of roaming traffic of the subscriber in the visiting country of the subscriber; restoring mobile communication of the subscriber upon detecting the subscriber's handset getting stuck in the VPMN due to an incomplete registration process, even when the subscriber has moved to one of the HPMN and a new VPMN; and creating CAMEL Subscription Information (CSI) for the subscriber by responding to one selected from a group consisting of: a registration message from the VPMN with nested update messages containing the CSI, and a registration response message from the VPMN with a standalone update message containing the CSI.

7. The method of claim 1, wherein the GLR is coupled to a configurable module that responds to selected signaling messages intended for the VPMN and originating from the HPMN, so as to facilitate the mobile communication of the subscriber.

8. The method of claim 7, wherein the selected signaling messages correspond to one selected from a group consisting of a Mobile Application Part (MAP) Send Routing Information (SRI), a MAP Send Routing Information For Short Message (SRI-SM), a MAP Send Routing Information for GPRS (SRI-GPRS), a MAP Send Routing Information For Location Service (SRI-LCS), a MAP Any Time Interrogation (ATI), and a MAP Any Time Subscription Interrogation (ATSI).

9. The method of claim 1, wherein the GLR shares the pool of GTs with a partner HPMN of the HPMN.

10. The method of claim 1, wherein the GLR modifies a first set of signaling messages exchanged between the HPMN and the VPMN by removing a Third Generation of mobile (3G) parameters from the first set of signaling messages, upon a determination being made that the HPMN has no 3G roaming agreement with the VPMN.

11. The method of claim 1, wherein the GLR determines whether the VPMN is deploying an add-on Signaling System #7 (SS7) node by monitoring roaming links between the HPMN and the VPMN.

12. A system for providing roaming services to a subscriber of a Home Public Mobile Network (HPMN), the subscriber being registered with a Visited Public Mobile Network (VPMN), the HPMN having one or more Home Location Registers (HLRs) and an associated Gateway Location Register (GLR), the system comprising:
an allocator for allocating a pool of Global Titles (GTs) to the GLR, the pool of GTs corresponding to the one or more HLRs, wherein the pool of GTs includes a plurality of GTs; and
a facilitator for facilitating, via the GLR, a mobile communication of the subscriber;
wherein more than one GT selected from the plurality of GTs is allocated to the GLR; and
wherein the GLR communicates with each one of the one or more HLRs via a different one from the selected one of the plurality of GTs in the pool.

13. The system of claim 12, further comprising:
a configurable module coupled to the GLR for responding to selected signaling messages intended for the VPMN and originating from the HPMN.

14. The system of claim 12, wherein the GLR shares the pool of GTs with at least one partner HPMN of the HPMN.

15. The system of claim 14, wherein the at least one partner HPMN has an associated gateway switching center, the gateway switching center communicating with the GLR via a leased line connection.

16. The system of claim 14, the at least one partner HPMN having an associated add-on SS7 node, the SS7 node communicating with the GLR by exchanging signaling messages using an encapsulation/de-capsulation technique.

17. The system of claim 14, the at least one partner HPMN having at least one subscriber and an associated roaming STP, the GLR having an associated international Signal Point Code (SPC), wherein the roaming STP communicates with the GLR by redirecting signaling messages corresponding to a subscriber associated with one of the at least one partner HPMN destined for the VPMN, to the international SPC.

18. The system of claim 14, the at least one partner HPMN having an associated roaming STP, the roaming STP supporting a Signaling Transport (SIGTRAN), a Stream Control Transmission Protocol (SCTP) and a MTP2 User Peer-to-peer Adaptation Layer (M2PA) protocol, the GLR supporting the SCTP and the MTP2A protocols, wherein the roaming STP communicates with the GLR by exchanging signaling messages over an Internet Protocol (IP) network.

19. The system of claim 14, the at least one partner HPMN having an associated roaming STP, the GLR having a pre-defined prefix, the VPMN being an original Called Party Address (CdPA) having an associated GT, wherein the roaming STP communicates with the GLR by configuring the roaming STP to add the pre-defined prefix to the GT of the original CdPA, so as to redirect signaling messages with the prefixed GT to the GLR.

20. The system of claim 14, the at least one partner HPMN having an associated roaming STP, the VPMN being an original Called Party Address (CdPA) having an associated first GT, the GLR having an associated second GT, wherein the roaming STP communicates with the GLR by configuring the roaming STP to replace the first GT with the second GT, so as to redirect signaling messages with the second GT to the GLR.

21. The system of claim 14, wherein one of the at least one partner HPMN is a sponsor HPMN, the sponsor HPMN having a GT and a roaming agreement with the VPMN, wherein the GLR is allocated the GT of the sponsor HPMN, so as to allow the at least one partner HPMN to communicate with the VPMN via the GLR.

22. A computer program product comprising a computer usable medium including a computer usable program code stored thereon, for providing roaming services to a subscriber of a Home Public Mobile Network (HPMN), the subscriber being registered with a Visited Public Mobile Network (VPMN), the HPMN having one or more Home Location Registers (HLRs) and an associated Gateway Location Register (GLR), the computer program product comprising:
means for allocating a pool of Global Titles (GTs) to the GLR, the pool of GTs corresponding to the one or more HLRs; and
means for facilitating, via the GLR, a mobile communication of the subscriber;
wherein more than one GT from the pool of GTs is allocated to the GLR; and
wherein the GLR communicates with each one of the one or more HLRs via a different one of the GTs in the pool.

23. A method for providing roaming services to a subscriber of a Home Public Mobile Network (HPMN), the subscriber equipment being registered with a Visited Public Mobile Network (VPMN), the HPMN having one or more Home Location Registers (HLRs) and an associated Gateway Location Register (GLR), the method comprising:
communicating, via the subscriber equipment, with a GLR that has allocated a pool of Global Titles (GTs), the pool of GTs including a plurality of GTs, the pool of GTs corresponding to the one or more HLRs; and
communicating, via the subscriber equipment, with at least one of the HLRs identified by at least one of those GTs.

24. A gateway location register apparatus for providing roaming services to a subscriber of a Home Public Mobile Network (HPMN), the subscriber being registered with a Visited Public Mobile Network (VPMN), the HPMN having one or more Home Location Registers (HLRs) and an associated Gateway Location Register (GLR), the apparatus comprising:
an allocator for allocating a pool of Global Titles (GTs) to the GLR, the pool of GTs corresponding to the one or more HLRs; and
a facilitator for facilitating, via the GLR, a mobile communication of the subscriber;
wherein more than one GT from the pool of GTs is allocated to the GLR; and
wherein the GLR communicates with each one of the one or more HLRs via a different one of the GTs in the pool.
